(19) United States
(12) Patent Application Publication
(10) Pub. No.: US 2024/0235887 A9
(43) Pub. Date: Jul. 11, 2024

(54) NETWORK NODE FOR A VEHICLE

(71) Applicant: Continental Automotive Technologies GmbH, Hannover (DE)

(72) Inventor: Helge Zinner, Regensburg (DE)

(73) Assignee: Continental Automotive Technologies GmbH, Hannover (DE)

(21) Appl. No.: 18/278,224

(22) PCT Filed: Feb. 3, 2022
(86) PCT No.: PCT/DE2022/200015

§ 371 Date: Aug. 22, 2023

(30) Foreign Application Priority Data
Feb. 22, 2021 (DE) 10 2021 201 663.4

(51) Int. Cl. H04L 12/40; H04L 43/0852; H04L 43/0888; H04L 43/106

(52) U.S. Cl. CPC H04L 12/4013; H04L 43/0852; H04L 43/0888; H04L 43/106; H04L 2012/40273

(57) ABSTRACT

A first network node for a vehicle communicates with a second network node and identifies a data transfer rate symmetry by: transmitting a first message and storing a first timestamp indicating the transmission time of the first message, transmitting a second message directly after transmitting the first message and storing a second timestamp indicating the transmission time of the second message, receiving a third message and storing a seventh timestamp indicating the transmission time of the third message, receiving a fourth message, which was transmitted after the third message, and storing an eighth timestamp indicating the transmission time of the fourth message. The first computing unit is configured for identifying, a data transfer rate symmetry by means of the first timestamp, the second timestamp, the seventh timestamp, and the eighth timestamp.

### BACKGROUND

The invention relates to a network arrangement for a vehicle, a first and a second network node, a method for identifying an asymmetric data transfer rate, and a vehicle.

Automotive Ethernet, like the IT Ethernet standards, too, currently always offers the same speed for the outgoing and return directions. Different data rates for download and upload will be available in the future, however. The time synchronization protocol PTP used in Automotive Ethernet, for the synchronization of the cameras, further ADAS functions and, in principle, all control devices with Ethernet connection, cannot however be employed for synchronization at different data rates. A further central problem is e.g. the parallel transfer with current in conjunction with low-frequency signal transfer. This has to be balanced at present by way of a specific circuit design. If knowledge of the inequality is available, this can be compensated for at the start of the current supply, for example, in order then to be able to react dynamically and to be able to prevent EMC problems.

### BRIEF SUMMARY

An object of the invention might therefore be to provide an arrangement and a method for identifying different data rates of a connection in a vehicle network.

The object is achieved by the subjects of the independent patent claims. The dependent claims, the following description, and the figures relate to advantageous embodiments.

The embodiments described relate in a similar manner to the network arrangement for a vehicle, the first and the second network node, the method for identifying an asymmetric data transfer rate, and the vehicle. Synergy effects can arise from different combinations of the embodiments, even though they may not be described in detail.

Furthermore, it should be noted that although all the embodiments of the present invention that relate to a method can be implemented in the described order of steps, this need not be the only and essential order of the steps of the method. Unless expressly stated otherwise below, the methods presented here can be implemented using a different order of the disclosed steps without departing from the associated method embodiment.

Technical terms are used with the meaning known to a person skilled in the art. If a specific meaning is attached to specific terms, definitions of terms are given below, in the context of which the terms are used. In this disclosure, the term “data transfer rate symmetry” is synonymous with “data rate symmetry”.

In accordance with a first aspect, a network node for a vehicle is provided, wherein the network node is a first network node and is configured to communicate with a further network node and to identify a data transfer rate symmetry. The first network node comprises a first communication unit and a first computing unit. The first communication unit is configured to identify a data transfer rate symmetry, comprising the steps:
S1: transmitting a first message N1 and storing a first timestamp t1 indicating the transmission time of the first message N1, by means of a first network node, S2: transmitting a second message N2 after transmitting the first message N1 and storing a second timestamp t2 indicating the transmission time of the second message N2, by means of the first network node, S3: receiving a third message N3 and storing a seventh timestamp t7 indicating the transmission time of the third message N3, by means of a first network node, S4: receiving a fourth message N4, which was transmitted after the third message N3, and storing an eighth timestamp t8 indicating the transmission time of the fourth message N4, by means of a first network node. In this case, the messages N1, N2, N3, N4 have at least approximately an identical data length or are projected onto an approximately identical data length. The first computing unit is configured for identifying, S5, a data transfer rate symmetry by means of the first timestamp t1, the second timestamp t2, the seventh timestamp t7 and the eighth timestamp t8.

In other words, the first communication module is configured to identify, on the basis of the timestamps mentioned, whether a data rate in the transmission direction is equal or not equal to the data rate in the reception direction, i.e. whether or not a data transfer rate symmetry is present. This is achieved by means of two messages in the transmission direction and two corresponding messages in the reception direction. The first communication module knows the times at which the first communication module transmitted the messages transmitted by it to e.g. a remote station, e.g. a second communication module, and the times at which the first communication module received the messages received by it. Furthermore, the first communication module is notified of the reception times when the first two messages were received by the remote station, by means of the two messages that the remote station transmits to the first communication module. What is important here is that the messages are each transmitted directly. The received messages, too, must be messages which have been generated directly successively since this achieves the effect, by means of the timestamps, that a time measurement of the message length, i.e. accordingly data rate multiplied by the number of the message length in bits, can be carried out. A separation interval between the messages respectively transmitted at one end is irrelevant at least for the determination of the data rate symmetry, as long as it is the same at both ends. It must be taken into account, however, for the data rate ratio described below. This can be done by means of an estimation or iteratively if this depends on the data rate.

The timestamps are defined for example as transmission or reception times relating to the transmission or reception of a specific bit of the message. For example, it relates to the first bit after a header.

Steps S1 to S4 can also be in a different order. For example, the order can be S1, S3, S2, S4, such that after the transmission of one message, e.g. N1, first a response message, e.g. N3, is received before the second message, e.g. N3, is transmitted. That is to say that in this case e.g. transmitting a second message N2 after transmitting the first message N1 is still effected, but a response message from the second network node is obtained in between times. The observations concerning the separation interval should be taken into consideration here.

It should be noted that, for the sake of clarity, this disclosure describes the case where the messages N1, N2, N3 and N4 have the same length in bits. However, it is self-evident to a person skilled in the art to take into account a length ratio N1/N3 or N2/N4 different than 1 e.g. by means of a factor. This case is covered by the wording “or projected onto an approximately identical data length”, but hereinafter is not explicitly included further.

In accordance with one embodiment, there is a time period d_a1 between the end of transmitting the first message N1 and the beginning of transmitting the message N2, and there is a time period d_a2 between the end of transmitting the third message N3 and the beginning of transmitting the message N4. Identifying the data rate ratio includes calculating the quotient Q from the difference t2−t1 between the first timestamp t1 and the second timestamp t2 and the difference between the seventh timestamp t7 and the eighth timestamp t8: Vdr=(t2−t1)/(t8−t7) taking account of the time periods d_a1 and d_a2. By this means, it is possible to identify not only whether a data rate symmetry is present, but also in which direction the data rate is higher or lower. If the data rate in the transmission direction is higher, then the two messages N1 and N2 are transmitted faster than the response messages from the remote station. Accordingly, the messages N3 and N4 take longer to receive. Consequently, the data rate in the transmission direction is higher if the quotient Vdr<1, and lower if the quotient Vdr>1. By virtue of latencies that may arise e.g. as a result of the processing in accordance with a transfer protocol, as a result of the hardware, etc., the quotient does not necessarily indicate the exact data transfer ratio. A separation interval possibly present between e.g. sending the last bit of the message N1 and the first bit of the message N2 may also influence the quotient Vdr and can be taken into account for the data rate ratio by subtracting it from the differences. The separation interval can be implemented by means of an estimation or iteratively if this depends on the data rate. However, it can for example also be measured once under defined conditions and the value or the values for different data rates can be stored. The time periods d_a1 and d_a2 can be equal. They can also be 0, such that the messages N1 and N2, and respectively N3 and N4, are transmitted directly successively. If d_a1 and d_a2 are approximately zero, they can also be disregarded. In the case where the message sequence is N1, N2, N3 and N4, it might be that this does not conform to a standard which, in the case of normal operation, provides for first transmitting a response message, i.e. the order N1, N3 and possibly also N5 and then N2, N4 and N6. Taking account of the time periods allows both types of order to be possible. In the case not conforming to a standard, it might be possible to switch momentarily to a different mode, e.g. a test mode.

For the decision as to whether a symmetry is present, it is also possible to specify an interval which takes overall account of these possible delays. Instead of ascertaining or estimating individual factors, the uncertainty interval of the quotient, i.e. Vdr lies in an interval (1+delta_x1) . . . (1−delta_x2) with the uncertainties delta_x1, delta_x2, for which a symmetry is assumed, can be chosen such that its limits respectively lie at the midpoint of two possible quotients of data transfer rates, for example 1 Gbit/s/0.75 Gbit/s=1.333, such that delta_x1=0.15, or conversely: 0.75 Gbit/s/1 Gbit/s=0.75, such that delta_x2=0.125. Other variants are possible.

With the quotient Vdr, possibly including the corrections described, it is also possible, finally, to determine the transmission or reception data rate if a reception or respectively transmission rate is known. It would also be possible to compare the quotient with possible quotients of available data rates in order to deduce both the transmission and the reception data rate.

In accordance with one embodiment, the first communication unit is furthermore configured to receive messages N5 and N6 containing the reception timestamps t5 and t6 of the messages N3 and N4; and wherein at least one of the received messages N3, N4 has at least one reception timestamp t3, t4 of the transmitted messages N1, N2, and the first computing unit is configured to calculate a propagation time of the messages N1, N2, N3 and N4, respectively, and/or to calculate a clock offset of a clock that determines the timestamps t3, t4, t5, t6 from the timestamps of one of the transmitted messages N1, N2 and one of the received messages N3, N4. The reception timestamps indicate the times at which the messages were received in the remote station. Since a message cannot contain its own transmission timestamp in the cases under consideration here, for example, said timestamp is transmitted in a subsequent message. The latter can be a message provided for this purpose in a standard. Since the transmission times of the messages N1 and N2 are known to the first communication module itself, and no calculations whatsoever are carried out at the remote station, the timestamps t1 and t2 do not need to be transferred to the remote station.

The propagation time and the clock offset of the clock that determines the timestamps t3, t4, t5, t6, i.e. the clock of the remote station, are thus calculated or estimated. The propagation time can be calculated e.g. using the messages N1, N3 in accordance with the formula d=((t3−t1)+(t7−t5))/2 known to a person skilled in the art, or accordingly using other combinations of transmission and reception messages. The clock offset then results from e.g. t1=(t3−clock offset)−d. The clock of the remote station is usually synchronized by means of the calculated clock offset.

In accordance with one embodiment, recognizing the data rate ratio before calculating the quotient Q comprises the step of determining a clock deviation from the difference deltaC between the difference t2−t1 between the timestamps t1, t2 and the difference t4−t3 between the reception timestamps of the transmitted messages N1, N2, and the data rate ratio is identified taking account of the clock deviation. In this case, “clock deviation” should be understood to mean a deviation resulting e.g. from a clock drift, a change in the clock drift or some other random and/or systematic deviations from a linear clock progression. Therefore, the clock deviation is a relative deviation of the clocks with respect to one another and should not be confused with the absolute clock offset described above. The clock deviation can be taken into account in the definition of the interval (1+delta_x1) . . . (1−delta_x2). Furthermore, it can be determined that an identification of the symmetry is not possible if the clock deviation is too great.

In accordance with one embodiment, the computing unit is furthermore configured to determine the clock deviation as a statistical value d_s from additional timestamps of further transmitted messages and the corresponding reception timestamps of the further transmitted messages. In other words, a statistical value or statistical values is/are calculated from a plurality of clock deviation determinations, such as, for example, a mean value, a standard deviation, etc. For this purpose, steps S1-S4 can be carried out repeatedly, thereby enabling the statistics.

In accordance with one embodiment, identifying the data rate inequality includes determining that the data transfer rate in the transmission direction is greater than that in the reception direction if the following holds true: (t2−t1)<((t8+d_S)−(t7−d_S)); the data transfer rate in the transmission direction is less than that in the reception direction if the following holds true: (t2−d_S−t1)>((t8−d_S)−(t7+d_S)); and otherwise the data transfer rates in the transmission direction and reception direction are equal. This can be used as an alternative method to the above-described identification of the symmetry, or as an additional condition.

In accordance with one embodiment, the communication unit is configured to repeatedly carry out steps S1 to S4, and the first computing unit is configured to calculate the timestamps t1, t2, t7 and t8 used for the identification of a data rate inequality in each case a value averaged over the repetitions from the respective individual timestamps t1, t2, t7 and t8, respectively. That is to say that one embodiment involves averaging over the individual values in order to compensate for statistical clock deviations, for example.

In accordance with one embodiment, the network node is an electronic control unit (ECU). Such a unit can be for example an antenna, a camera, a radar sensor or some other corresponding unit for a vehicle that is known to a person skilled in the art.

In accordance with one embodiment, the transfer protocol is an Ethernet protocol.

In accordance with one embodiment, the messages N1 and N2 are Ethernet-PDelay_Request messages and the messages N3 and N4 are Ethernet-PDelay_Response messages of the Ethernet protocol.

In accordance with one embodiment, the computing unit is furthermore configured to check, on the basis of the calculated data transfer rate, whether transfer of current in the transmission direction is operated with sufficiently high frequency to avoid interference, and to adapt the frequency accordingly, and/or to regulate a current supply of the network node.

In accordance with one aspect, a network arrangement for a vehicle is provided. The network arrangement comprises a first network node described herein, and a second network node having a second communication unit. The second communication unit is configured to communicate with the first communication unit of the first network node, and to receive the message N1 of the first communication unit of the first network node and to generate a reception timestamp t3, to receive the message N2 of the first communication unit of the first network node and to generate a reception timestamp t4, to provide and to transmit the message N3 containing the generated reception timestamp t3, and to provide and to transmit the message N4 containing the generated reception timestamp t4.

In accordance with one aspect, a second network node for a network arrangement is provided. Like the first network node, the second network node can be an ECU for a vehicle.

In accordance with a further aspect, a method for identifying an asymmetric data transfer rate in a network arrangement (100) for a vehicle (500) comprising the following steps is provided:
S1: transmitting a first message N1 and storing a first timestamp t1 indicating the transmission time of the first message N1, by means of a first network node;
S2: transmitting a second message N2 directly after transmitting the first message N1 and storing a second timestamp t2 indicating the transmission time of the second message N2, by means of the first network node;
S3: receiving a third message N3 and storing a seventh timestamp t7 indicating the transmission time of the third message N3, by means of a first network node;
S4: receiving a fourth message N4, which was transmitted directly after the third message N3, and storing an eighth timestamp t8 indicating the transmission time of the fourth message N4, by means of a first network node;
wherein the messages N1, N2, N3, N4 have at least approximately an identical data length; and
and wherein the network node furthermore comprises a first computing unit configured for
S5: identifying a data rate symmetry by means of the first t1, second t2, seventh t7 and eighth t8 timestamps.

In accordance with a further aspect, a vehicle is provided which comprises a network arrangement having a first and a second network node as described herein.

Furthermore, a computer program element can be configured, when it is executed on the computing unit of the first network node, to instruct the network node to carry out the steps of the method described here. A computer-readable medium which is part of the network node or which can be accessed by the network node can contain the program element. The computer program element can be part of a computer program, but it can also be a whole program by itself. For example, the computer program element can be used to update a computer program already available, in order to arrive at the present invention. The computer-readable medium can be regarded as a storage medium, such as, for example, a USB stick, a CD, a DVD, a data storage device, a hard disk or any other medium on which a program element as described above can be kept stored.

The invention thus allows the identification of a data rate symmetry or asymmetry and the determination of different data rates in the transmission and reception directions in a computing unit of a first network node. The computing unit of a second network node is not required. Additional hardware is not required. With knowledge of the inequality, it is furthermore possible for example to determine the direction in which the supply current is intended to flow. In addition to that, the knowledge can be utilized in order to adapt the return channel so that no interference occurs with a parallel current supply, e.g. in the case where the return channel is too slow. The invention additionally affords the possibility of testing the media, in order also to identify faults which arise in the configuration or in the cabling. These tests are not only invisible but also require no additional resources at all.

Furthermore, it is sufficient to transmit and receive standardized messages and to evaluate the timestamps. With knowledge of the speed, the application can be optimized or designed with respect to memory usage, (ROM, RAM), real-time capability and possible security levels. With dynamic adaptation of the software to the data rate, the software can be applied appositely. The synchronization is thus improved, as a result of which the quality of the sensor data increases as well.

The invention furthermore allows software developers and software architects to provide software/applications that can be tailored to the requirements of the application more flexibly and precisely, in a manner independent of the data rate.

### BRIEF DESCRIPTION OF THE DRAWINGS

Exemplary embodiments of the invention are explained in more detail below with reference to the schematic drawings.

FIG. 1 shows a network arrangement in accordance with one exemplary embodiment.

FIG. 2 shows a first timing diagram in accordance with one exemplary embodiment.

FIG. 3 shows a second timing diagram in accordance with a further exemplary embodiment.

FIG. 4 shows a flow diagram of a method in accordance with a further exemplary embodiment.

FIG. 5 shows a vehicle in accordance with one exemplary embodiment.

In all of the figures, mutually corresponding parts are provided with the same reference signs.

### DETAILED DESCRIPTION

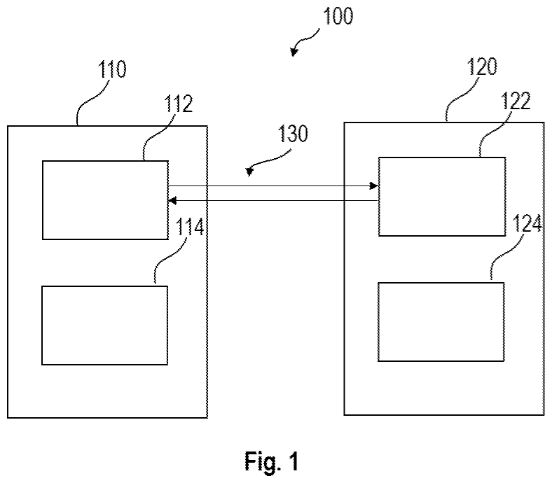

FIG. 1 shows a network arrangement 100 for a vehicle in accordance with one exemplary embodiment. The network arrangement 100 comprises a first network node 110 having a first communication unit 112 and a first computing unit 114, and also a first network node 110 having a first communication unit 112 and a second computing unit 124. The network nodes 110, 120 communicate with one another by means of the communication units 112 and 122 via the connection 130. From the standpoint of the network node 110, the connection 130 has a transmission direction and a reception direction, wherein the data rates in these two directions can be identical or different, i.e. the data rates can be “symmetric” or “asymmetric”.

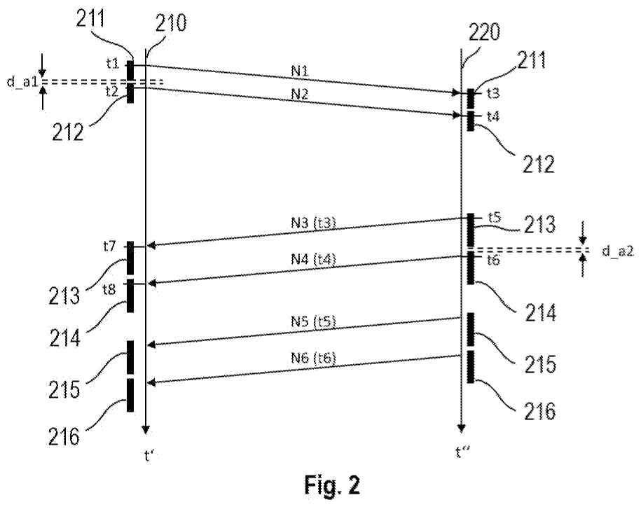

FIG. 2 shows a timing diagram in accordance with one exemplary embodiment. The reference sign 210 denotes the time axis of the first communication unit 110 with the time scale t′, and the reference sign 220 denotes the time axis of the second communication unit 120 with the time scale t″. The communication unit 110 transmits a message N1 211 to the second communication unit 120. When transmitting the message N1 211, the first communication unit 110 generates a timestamp t1 relating to the transmission time of the first bit after the header of the message N1 211. The further timestamps t2 to t8 will correspondingly relate to the transmission or reception time of the first bit after the header. The arrows illustratively indicate the transfer of the bit assigned to the timestamp; the message in its entirety is transmitted only with the lower end of a data block, e.g. 211, and is fully received by the first communication unit 110 later after the propagation time. The same correspondingly applies to all the messages depicted. The message N1 211 is received with timestamp t3 by the second communication unit 120. A second message N2 212 is transmitted directly after the first message N1 211, wherein the timestamps t2 and t3 are generated. The second communication unit 120 thereupon transmits response messages N3 213 and N4 214 containing the timestamps t3 and t4, and the timestamps t5 and t7 and respectively t6 and t8 are generated in the process. The messages serve merely for transferring the timestamps t5 and respectively t6. With the messages N5 215 and N6 216, the timestamps t5 and respectively t6 are transmitted to the first communication unit 112 by the second communication unit 122. As can be seen in FIG. 2, the messages N1 and N2 are shorter than the messages N3 213 and respectively N4 214 on the time scales t′ and respectively t″. It should be assumed here that they have the same number of bits, however. In the case of different bit numbers, a virtual equality can be created by applying a corresponding factor. If the messages are shorter on the time scales in the transmission direction than in the reception direction from the standpoint of the first communication unit 112, this is identified by the first computing unit 124 as a higher data transfer rate in the transmission direction. For this purpose, the first computing unit 124 evaluates the timestamps t1, t2, t7 and t8 by comparing e.g. the difference t8−t7 with the difference t2−t1. Alternatively or additionally, the timestamps t3, t4, t5 and t6 can be evaluated. However, it is also possible to form the quotient of the two differences, as a result of which it is possible to determine a ratio of the data rates and thus also an absolute data rate if the first computing unit 124 knows one of the two data rates, or knows representative ratios for constellations of transmission and reception data rates. Various corrections can be made when calculating the differences or quotients. By way of example, it is possible to take account of a separation interval d_a1 and respectively d_a2, which is depicted in FIG. 2 merely illustratively for the transmission separation of the messages N1 and N2 and respectively N3 and N4. The separation interval can be different or identical for the first and second nodes. Furthermore, statistics of the time scales t′, t″ can be created, which indicate the statistical or alternatively systematic deviations of the clocks from one another, and which are taken into account for example by an interval in which the quotient for the identification of an equality is permitted to range. Furthermore, it is possible to take account of latencies, for example, which can arise e.g. during the generation of the timestamps on account of the processing. These latencies can also be data-rate-dependent under certain circumstances. Furthermore, the propagation time of the messages and the clock offset of the two clocks can be determined, which clock offset can be used for the synchronization of the clocks. For this purpose, it is possible to form an arbitrary pair from one of the transmitted messages N1, N2 and one of the received messages N3, N4 and to evaluate the timestamps thereof. A statistical value can also be ascertained on account of the redundancy.

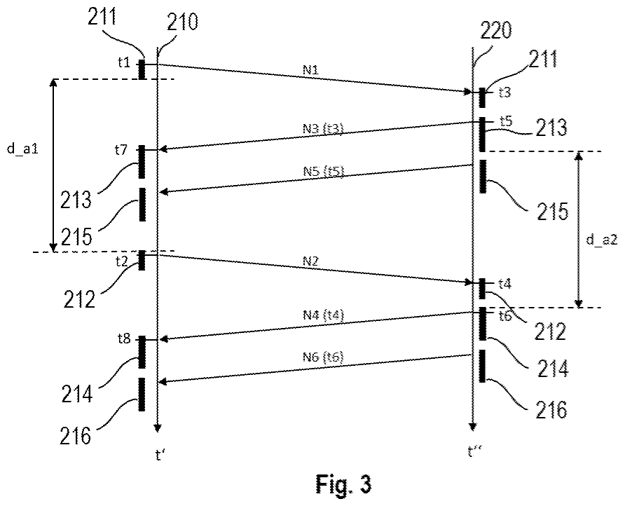

FIG. 3 shows a further timing diagram in accordance with one exemplary embodiment, which differs from the timing diagram in terms of the message sequence, which here is N1, N3, N5, N2, N4, N6. That is to say that firstly the message N1 and the response messages are transmitted before the second message with the response messages N4 and N6 are transmitted. The separation intervals d_a1 and d_a2 change accordingly. They are furthermore depicted with different magnitudes in FIG. 3. The designations of the messages and the assigned timestamps correspond to the messages in FIG. 2. In order that the quotient of the difference t8−t7 and the difference t2−t1 is meaningful, the separation intervals d_a1 and d_a2 have to be taken into account, e.g. by subtracting them from the differences.

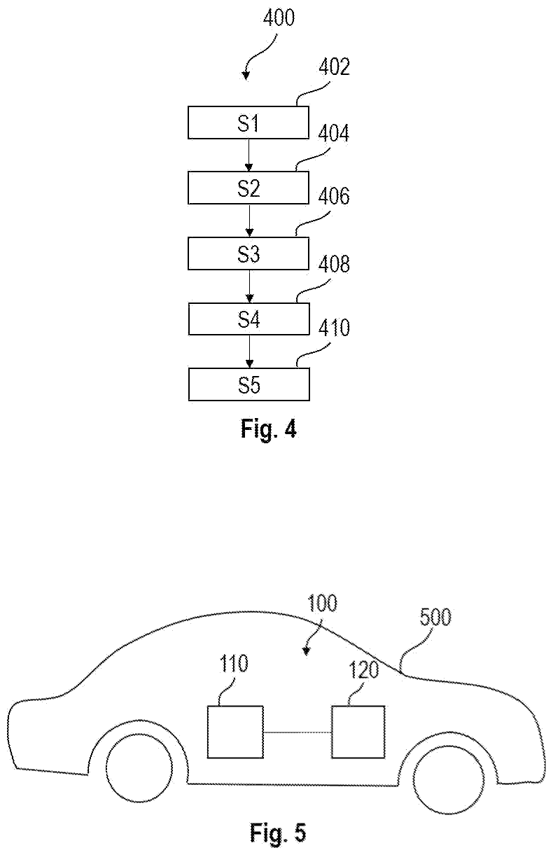

FIG. 4 shows a flow diagram of a method in accordance with one exemplary embodiment. In a first step S1, 402, by means of a first network node 110, a first message N1 is transmitted to a second network node 120 and a first timestamp t1 indicating the transmission time of the first message N1 is stored. In step S2, 404, by means of the first network node 110, a second message N2 is transmitted directly after transmitting the first message N1 and a second timestamp t2 indicating the transmission time of the second message N2 is generated. In a third step S3, 406, a third message N3 is received by a first network node and a seventh timestamp t7 indicating the reception time of the third message N3 is generated. In this case, the received message N3 was transmitted by the second network node 120. Furthermore, a timestamp t5 was generated by the second network node 120. In a fourth step S4, 408, by means of a first network node, a fourth message N4, which was transmitted directly after the third message N3, is received and an eighth timestamp t8 indicating the transmission time of the fourth message N4 is stored. In this case, the received message N4 was transmitted by the second network node 120. Furthermore, a timestamp t6 was generated for the message N4 by the second network node 120. The messages N1, N2, N3, N4 have at least approximately an identical data length or an unequal data length is taken into account by means of a factor, for example. The first computing unit 114 of the first network node 110 furthermore carries out step S5, 410, in which a data rate symmetry is identified by means of the first timestamp t1, the second timestamp t2, the seventh timestamp t7 and the eighth timestamp t8.

FIG. 5 shows a vehicle 500 in accordance with one exemplary embodiment having a network arrangement 100 comprising a first network node 110 and a second network node 120.

In carrying out the claimed invention, a person skilled in the art can understand and implement other variations of the disclosed embodiments through studying the drawings, the disclosure and the accompanying claims. The word “comprising” in the claims does not exclude other elements or steps, and the indefinite article “a” or “an” does not exclude more than one. A single processor or another unit can fulfil the functions of a plurality of objects or steps presented in the claims. The mere fact that certain measures are specified in mutually dependent claims does not mean that a combination of these measures cannot be used advantageously. A computer program can be stored/distributed on a suitable medium such as an optical storage medium or a semiconductor medium, which is supplied together with or as part of other hardware, but can also be distributed in other forms, for example via the Internet or other wired or wireless telecommunication systems. Reference signs in the claims should not be construed as limiting the scope of the claims.

1. A network node for a vehicle, wherein the network node is a first network node configured to communicate with a second network node and to identify a data transfer rate symmetry, comprising a
a first communication unit configured to carry out the following steps:
S1: transmitting a first message N1 and storing a first timestamp t1 indicating the transmission time of the first message N1;
S2: transmitting a second message N2 after transmitting the first message N1 and storing a second timestamp t2 indicating the transmission time of the second message N2;
S3: receiving a third message N3 and storing a seventh timestamp t7 indicating the transmission time of the third message N3;
S4: receiving a fourth message N4, which was transmitted after the third message N3, and storing an eighth timestamp t8 indicating the transmission time of the fourth message N4;
wherein the messages N1, N2, N3, and N4 have at least approximately an identical data length or are projected onto an approximately identical data length; and
wherein the network node furthermore comprises a first computing unit configured for
S5: identifying a data transfer rate symmetry by means of the first t1, second t2, seventh t7, and eighth t8 timestamps.

2. The network node as claimed in claim 1, wherein
there is a time period d_a1 between the end of transmitting the first message N1 and the beginning of transmitting the second message N2;
there is a time period d_a2 between the end of transmitting the third message N3 and the beginning of transmitting the fourth message N4;
identifying the data rate ratio includes calculating the quotient Q from the difference t2−t1 between the first timestamp t1 and the second timestamp t2 and the difference between the seventh timestamp t7 and the eighth timestamp t8: Vdr=(t2−t1)/(t8−t7) taking account of the time periods d_a1 and d_a2.

3. The network node as claimed in claim 1, wherein
the first communication unit is furthermore configured to receive messages N5 and N6 containing the reception timestamps t3 and t4 of the third message N3 and the fourth message N4; and wherein at least one of the received messages N3, N4 has at least one reception timestamp t3, t4 of the transmitted messages N1, N2, and the first computing unit is configured to calculate a propagation time of the messages N1, N2, N3 and N4, respectively, and/or to calculate a clock offset of a clock that determines the timestamps t3, t4, t5, t6 from the timestamps of one of the transmitted messages N1, N2 and one of the received messages N3, N4.

4. The network node as claimed in claim 1, wherein recognizing the data rate ratio before calculating the quotient Q comprises the step of determining a clock deviation from the difference deltaC between the difference t2−t1 between the timestamps t1, t2 and the difference t4−t3 between the reception timestamps of the transmitted messages N1, N2, and the data rate ratio is identified taking account of the clock deviation.

5. The network node as claimed in claim 4, wherein the computing unit is configured to determine the clock deviation as a statistical value d_s from additional timestamps of further transmitted messages and the corresponding reception timestamps of the further transmitted messages.

6. The network node as claimed in claim 4, wherein identifying the data rate inequality includes determining that
the data transfer rate in the transmission direction is greater than that in the reception direction if the following holds true: (t2−t1)<((t8−d_S)−(t7−d_S));
the data transfer rate in the transmission direction is less than that in the reception direction if the following holds true: (t2−d_S−t1)>((t8−d_S)−(t7+d_S)); and
otherwise the data transfer rates in the transmission direction and reception direction are equal.

7. The network node as claimed in claim 1, wherein the first communication unit is configured to repeatedly carry out steps S1 to S4, and the computing unit is configured to calculate the timestamps t1, t2, t7, and t8 used for the identification of a data rate inequality in each case a value averaged over the repetitions from the respective individual timestamps t1, t2, t7 and t8, respectively.

8. The network node as claimed in claim 1, wherein the network node is an electronic control unit (ECU).

9. The network node as claimed in claim 1, wherein the transfer protocol is an Ethernet protocol.

10. The network node as claimed in claim 9, wherein the messages N1 and N2 are Ethernet-PDelay_Request messages, and the messages N3 and N4 are Ethernet-PDelay_Response messages.

11. The network node as claimed in claim 10, wherein the computing unit is furthermore configured to check, on the basis of the calculated data transfer rate,
whether transfer of current in the transmission direction is operated with sufficiently high frequency to avoid interference, and to adapt the frequency accordingly; and/or
to regulate a current supply of the network node.

12. A network arrangement for a vehicle, comprising a first network node configured to communicate with a second network node and to identify a data transfer rate symmetry, comprising a
a first communication unit configured to carry out the following steps:
S1: transmitting a first message N1 and storing a first timestamp t1 indicating the transmission time of the first message N1;
S2: transmitting a second message N2 after transmitting the first message N1 and storing a second timestamp t2 indicating the transmission time of the second message N2;
S3: receiving a third message N3 and storing a seventh timestamp t7 indicating the transmission time of the third message N3;
S4: receiving a fourth message N4, which was transmitted after the third message N3, and storing an eighth timestamp t8 indicating the transmission time of the fourth message N4;
wherein the messages N1, N2, N3, and N4 have at least approximately an identical data length or are projected onto an approximately identical data length; and
wherein the network node furthermore comprises a first computing unit configured for
S5: identifying a data transfer rate symmetry by means of the first t1, second t2, seventh t7, and eighth t8 timestamps; and
a second network node comprising a second communication unit, wherein the second communication unit is configured to communicate with the first communication unit of the first network node, and
to receive the message N1 of the first communication unit of the first network node and to generate a reception timestamp t3;
to receive the message N2 of the first communication unit of the first network node and to generate a reception timestamp t4;
to provide and to transmit the message N3 containing the generated reception timestamp t3; and
to provide and to transmit the message N4 containing the generated reception timestamp t4.

13. (canceled)

14. A method for identifying an asymmetric data transfer rate in a network arrangement for a vehicle comprising the steps:
S1: transmitting a first message N1 and storing a first timestamp t1 indicating the transmission time of the first message N1, via a first network node;
S2: transmitting a second message N2 directly after transmitting the first message N1 and storing a second timestamp t2 indicating the transmission time of the second message N2, via the first network node;
S3: receiving a third message N3 and storing a seventh timestamp t7 indicating the transmission time of the third message N3, via the first network node;
S4: receiving a fourth message N4, which was transmitted after the third message N3, and storing an eighth timestamp t8 indicating the transmission time of the fourth message N4, via the first network node;
wherein the messages N1, N2, N3, and N4 have at least approximately an identical data length; and
S5: identifying a data rate symmetry by means of the first t1, second t2, seventh t7, and eighth t8 timestamps, via the first network node.

15. A vehicle comprising a network arrangement comprising a first network node configured to communicate with a second network node and to identify a data transfer rate symmetry, the network arrangement further comprising
a first communication unit configured to carry out the following steps:
S1: transmitting a first message N1 and storing a first timestamp t1 indicating the transmission time of the first message N1;
S2: transmitting a second message N2 after transmitting the first message N1 and storing a second timestamp t2 indicating the transmission time of the second message N2;
S3: receiving a third message N3 and storing a seventh timestamp t7 indicating the transmission time of the third message N3;
S4: receiving a fourth message N4, which was transmitted after the third message N3, and storing an eighth timestamp t8 indicating the transmission time of the fourth message N4;
wherein the messages N1, N2, N3, and N4 have at least approximately an identical data length or are projected onto an approximately identical data length; and
wherein the network node furthermore comprises a first computing unit configured for
S5: identifying a data transfer rate symmetry by means of the first t1, second t2, seventh t7, and eighth t8 timestamps; and
a second network node comprising a second communication unit, wherein the second communication unit is configured to communicate with the first communication unit of the first network node, and
to receive the message N1 of the first communication unit of the first network node and to generate a reception timestamp t3;
to receive the message N2 of the first communication unit of the first network node and to generate a reception timestamp t4;
to provide and to transmit the message N3 containing the generated reception timestamp t3; and
to provide and to transmit the message N4 containing the generated reception timestamp t4.
